(19) United States
(12) Patent Application Publication
(10) Pub. No.: US 2009/0089373 A1
(43) Pub. Date: Apr. 2, 2009

(54) SYSTEM AND METHOD FOR IDENTIFYING SPAM HOSTS USING STACKED GRAPHICAL LEARNING

(75) Inventors: Debora Donato, Barcelona (ES); Aristides Gionis, Barcelona (ES); Vanessa Murdock, Barcelona (ES); Fabrizio Silvestri, Pisa (IT)

Correspondence Address: YAHOO! INC. C/O GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 11/863,486

(22) Filed: Sep. 28, 2007

(51) Int. Cl. G06F 15/16

(52) U.S. Cl. 709/205

(57) ABSTRACT

Systems and methods for identifying spam hosts are disclosed in which hosts known to the system and initially classified as spam or non-spam by a baseline classifier. Then for each node u in the host graph a new feature is computed. This feature is an aggregate function of the initial classifications produced by the baseline classifier for the neighbors of the node u. The set of neighbors can be defined in many different ways: in-link neighbors, out-link neighbors, bi-directional neighbors, k-hops neighbors, etc. The new feature computed above then is added to the existing set of features, and the baseline classifier is trained again, producing new predictions for each node. The results may then be used in many different ways including to filter search results based on host classifications so that spam hosts are not displayed or displayed last in a results set.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

With the increased use of online advertising models that reward the owners of web hosts whenever an advertisement is viewed (pay-per-view advertising) or clicked on (pay-per-click advertising), it has become common for people to create hosts solely for the purpose of getting advertisements viewed by users. Such hosts are referred to as “spam” hosts (because of their similarity to “spam” e-mail, i.e., they are unsolicited displays of advertising) to distinguish them from hosts that primarily provide content of value (e.g., news articles, blogs, some service, etc.), other than advertisements.

Because most hosts on the Internet are found through search engines such as those provided by Yahoo! and Google, operators of spam hosts have incentive to make their hosts appear as close to the top in the results of any given search query entered into a search engine. Spam host operators typically do this by placing random or targeted content and links on the pages of their hosts in order to trick the analysis algorithms used by search engines into classifying the spam host higher in a given query's search results.

Conversely, the operators of the search engines recognize that those users performing searches are not interested viewing spam hosts. Thus, search engines have an incentive to make spam hosts appear near or at the bottom of the search results generated by any given search query or omit the spam hosts altogether from the search results. However, achieving this is complicated because it can be difficult to identify spam hosts without manually reviewing the content of each host and classifying it as a spam or non-spam host.

### SUMMARY

Systems and methods for identifying spam hosts are disclosed in which hosts known to the system are initially classified as spam or non-spam by a baseline classifier. Then for each node u in the host graph a new feature is computed. This feature is an aggregate function (average, minimum, maximum, harmonic mean, weighted mean, etc.) of the initial classifications produced by the baseline classifier for the neighbors of the node u. The set of neighbors can be defined in many different ways: in-link neighbors, out-link neighbors, bi-directional neighbors, k-hops neighbors, etc. The new feature computed above then is added to the existing set of features, and the baseline classifier is trained again, producing new predictions for each node. The results may then be used in many different ways including to filter search results based on host classifications so that spam hosts are not displayed or displayed last in a results set.

In one aspect, the disclosure describes a method for identifying spam hosts within a set of hosts. The method includes indexing content on each host within the set of hosts on a network and indexing links on each host within the set of hosts on the network. Then each host is classified with a host spamicity value identifying the host as spam or non-spam based on an analysis of the information known about that host. Each host is then analyzed separately and for each host, a neighbor spamicity value is determined based on the initial spamicity values of neighbors of the particular host. Each host is then assigned a final host spamicity value identifying the host as spam or non-spam based on a second analysis of the information known about the host and the neighbor spamicity value of the neighbors of the host.

In another aspect, the disclosure describes a computer-readable medium storing computer executable instructions for a method of presenting a list of hosts as search results in response to a search query. The method includes receiving, from a requestor, a search query requesting a list of hosts matching a search term and identifying hosts matching the search term. A host spamicity value is assigned to each host matching the search term, based on content and links on that host and content and links of neighbors of that host, the host spamicity value of each host identifying the host as either a spam host or a non-spam host. The list of the hosts matching the search term is then presented to the requestor after the list has been sorted at least in part based on the host spamicity value of each host in the list.

In another aspect, the disclosure describes a system for generating a list of search results. The system includes a spam host identification module that identifies each of a plurality of hosts as either a spam host or a non-spam host based on content and links on that host and further based on content and links of neighbors of that host, the spam host identification module further includes a prediction module that initially classifies each host in the plurality of hosts as either a spam host or a non-spam host based on at least the content on that host. The spam host identification module may include a neighbor spamicity module that determines a neighbor spamicity value for each host, in which the neighbor spamicity value based on an initial classification of neighboring hosts based on links between each host and other hosts. The spam host identification module may further include a reclassification module that changes the initial classifications for at least some of the hosts based on the content of the host and the neighbor spamicity value of the host. The system may include an index containing information describing the content and links of a set of hosts on a network and a search engine that receives a search query including a search term, identifies hosts matching the search term based on information contained in the index, and transmits a list of hosts matching the search term in which the order in which the hosts matching the search term appear in list is based at least in part on whether the host is identified as a spam host or a non-spam host by the spam host identification module.

In yet another aspect, the disclosure describes a computer-readable medium storing computer executable instructions for a method for identifying spam hosts within a set of hosts. The method includes assigning each host an initial host spamicity value identifying the host as spam or non-spam based on an first analysis of the information known about that host. The method then, for a first host, determines a neighbor spamicity value based on the initial spamicity values of neighbors of the first host. The method then assigns the first host a final host spamicity value identifying the host as spam or non-spam based on a second analysis of the information known about the first host and the neighbor spamicity value of the neighbors of the first host.

These and various other features as well as advantages will be apparent from a reading of the following detailed description and a review of the associated drawings. Additional features are set forth in the description that follows and, in part, will be apparent from the description, or may be learned by practice of the described embodiments. The benefits and features will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The following drawing figures, which form a part of this application, are illustrative of embodiments systems and methods described below and are not meant to limit the scope of the disclosure in any manner, which scope shall be based on the claims appended hereto.

FIG. 1 illustrates an embodiment of a computing architecture for identifying spam hosts on a network.

FIG. 2 illustrates the elements of an example host.

FIG. 3 illustrates a method for identifying spam hosts within a set of hosts.

FIG. 4 illustrates an embodiment of a method that identifies spam hosts and uses that information to change how search results are presented to users in a search system.

FIG. 5 shows a histogram of the minimum ratio change of the number of neighbors from distance i to distance i−1.

FIG. 6 shows a histogram of the query precision in non-spam vs. spam pages for k=500.

### DETAILED DESCRIPTION

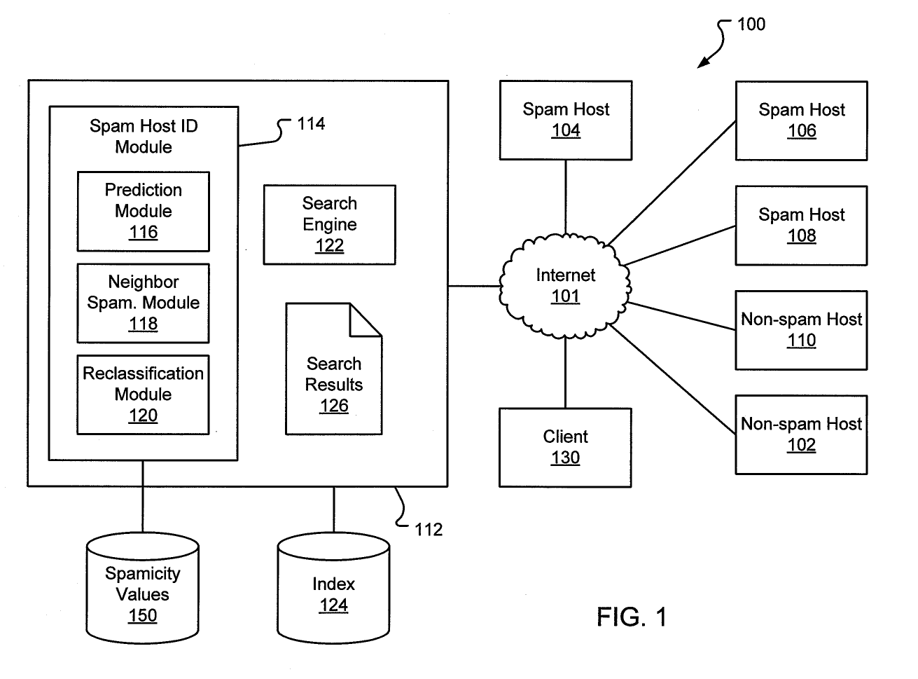

FIG. 1 illustrates an embodiment of a computing architecture including a system for identifying spam hosts on a network. The architecture 100 is a computing architecture in which any number of hosts (five are shown) 102, 104, 106, 108, 110 are connected to a network which, in the embodiment shown, is the Internet 101. A host is a node on a computer network from which content can be obtained and indexed by a search engine 122. Depending on the desires of the system operator, each host may correspond to a different computing device (commonly referred to as a server), top level domain name (TLD) (e.g., “cnn.com”), or individual web page on the network 101. In the embodiment described herein, each host will correspond to a different computing device, which may host one or more TLDs and multiple web pages. However, the reader will understand that the systems and methods described herein could be easily adapted to any different definition of host.

A host on the network 101 may be identified by a address or identifier such as an IPv4 address (e.g., 111.012.1.115) or IPv6 address (such as 2001:0db8:85a3:08d3:1319:8a2e:0370:7334). The systems and methods described herein will classify each host 102, 104, 106, 108, 110 as either spam or non-spam. Because each host may provide access to one or more web pages or other types of content, classifying a host as spam will result in the classification of web pages on the host as spam also. For example, in an embodiment in which the TLD “www.cnn.com” is on a host 102, all the web pages and other content accessible via sub domains under the TLD (e.g., cnn.com/politics/todaysstory.htm and cnn.com/technology/fuelcell.htm) are classified the same as that host 102.

The architecture 100 illustrated is a networked client/server architecture in which some of the computing devices, such the hosts 102, 104, 106, 108, 110 are referred to as a “server” in that they serve requests for content (e.g., web pages and services) and other computing devices are referred to as a “client” that issue requests for content to servers. For example, in the embodiment shown the spam identification module 114 is incorporated into a server 112 that can serve web page search requests from clients, such as the client computing device 130 shown. The systems and methods described herein are suitable for use with other architectures as discussed in greater detail below.

Computing devices are well known in the art. For the purposes of this disclosure, a computing device such as the client 130, server 112 or host 102, 104, 106, 108, 110 includes a processor and memory for storing and executing data and software. Computing devices may be provided with operating systems that allow the execution of software applications in order to manipulate data. Examples of operating systems include an operating system suitable for controlling the operation of a networked server computer, such as the WINDOWS XP or WINDOWS 2003 operating systems from MICROSOFT CORPORATION.

In order to store the software and data files, a computing device may include a mass storage device in addition to the memory of the computing device. Local data structures, including discrete web pages such as .HTML files, may be stored on a mass storage device (not shown) that is connected to, or part of, any of the computing devices described herein. A mass storage device includes some form of computer-readable media and provides non-volatile storage of data for later use by one or more computing devices. Although the description of computer-readable media contained herein refers to a mass storage device, such as a hard disk or CD-ROM drive, it should be appreciated by those skilled in the art that computer-readable media can be any available media that can be accessed by a computing device.

By way of example, and not limitation, computer-readable media may comprise computer storage media and communication media. Computer storage media include volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassette, magnetic tape, magnetic disk storage or other magnetic storage devices, or any other medium which can be used to store the desired information and which can be accessed by the computer.

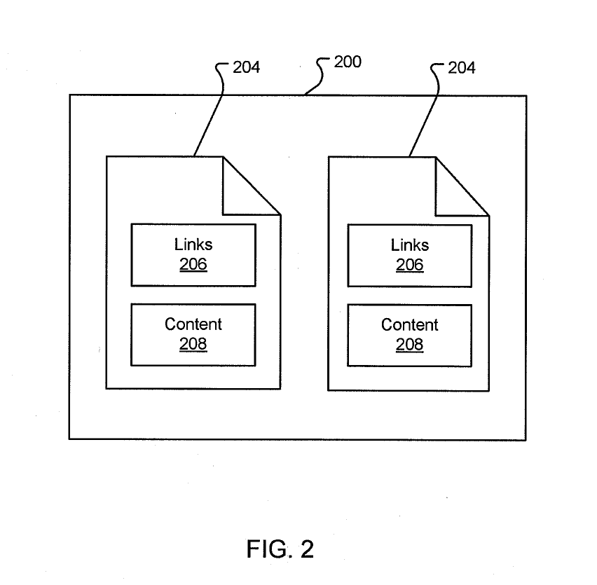

As discussed above, FIG. 1 illustrates a plurality of hosts on a network 101. The FIG. illustrates five hosts 102, 104, 106, 108, 110, each of which is further identified as either a spam host 104, 106, 108, or a non-spam host 102, 110. As discussed with reference to FIG. 2, each host may include one or more pages of information, e.g., web pages, which may contain content and/or one or more links to other web pages one the same host or on different hosts.

As shown in FIG. 1, an internet search server 112 that includes a system for detecting and identifying spam hosts is also provided. The server 112 may be a server computer as shown or a module on a single server computer or distributed across multiple server computers. The server 112 is connected to the Internet 101 and, thus, has access to all the pages of the various hosts 102-110 that are also connected to the Internet 101.

The server 112 includes a number of modules. The term module is used to remind the reader that the functions and systems described herein may be embodied in a software application executing on a processor, in a piece of hardware purpose-built to perform a function or in a system embodied by a combination of software, hardware and firmware.

The server 112 includes a spam host identification module 114 as shown. As discussed in greater detail below, the spam host identification module 114 takes information previously indexed about the hosts, such as by a search engine 122 or web crawler (not shown), initially classifies all of the hosts as either a spam host or non-spam host, then, by analyzing the neighbors of a given host may further reclassify the host for a final classification as either spam or non-spam.

In the embodiment shown, the spam host identification module 114 includes a prediction module 116. The prediction module 116 analyzes the information in the index 124 and initially classifies each host with a value indicative of the results of a preliminary analysis of whether that host is a spam host or a non-spam host. This value shall be referred to as the host “spamicity” value. In an embodiment, the spamicity value may be a simple binary 0 or 1, such that, for example, 1 indicates a spam host and 0 indicates a non-spam host (or vice versa). Alternatively, a more complicated algorithm may be used that provides a host spamicity value ranging between an upper limit and a lower limit that reflects the confidence of the algorithm in identifying a host as spam or non-spam.

In the embodiment shown, the spamicity values for hosts evaluated by the spam host identification module 114 are stored in a classification datastore 150. In an alternative embodiment, the spamicity values or equivalent information classifying hosts as spam/non-spam may be stored in the index 124 of host information so that all host information is stored in a single datastore.

In addition to the prediction module, an neighbor spamicity module 118 is provided as shown. The neighbor spamicity module 118 determines an spamicity value of each host's neighbors (i.e., a spamicity value representative of the hosts that are linked to a given host). When determining if two hosts are neighbors, the direction of the link the may or may not be considered. For example, if host A has a link to host B then host A is said to have an “out-link” or be out-linked to host B and host B is said to have an “in-link” from or be in-linked to host B. Depending on the definition of neighbor used by the system, only in-link neighbors, out-link neighbors, bi-directional neighbors (i.e., host A and host B are both in-linked and out-linked to each other), or k-hop neighbors (host A is linked to host B through some mutual chain of linked hosts in which the chain is less than or equal to k links) may be used.

The neighbor spamicity module 118 may determine the neighbor spamicity value by any suitable algorithm. For example, the neighbor spamicity value may be a simple average of the initial spamicity values of each neighbor. Alternatively, the neighbor spamicity value may be some weighted average, for example wherein each spam host is weighted more than a non-spam host. In yet another embodiment, an aggregating function may be used that takes into account how many links there are in each neighbor.

The spam host identification module 114 further includes a reclassification module 120 as shown. The reclassification module 120 uses the neighbor spamicity value determined by the neighbor spamicity module I 1 8 and subsequently reclassifies each of the hosts as either spam or non-spam based on the neighbor spamicity value. Because the neighbor spamicity value is based on the initial host spamicity values generated by the prediction module 116, reclassifying is ultimately based on both the results of the neighbor spamicity module 118 and the results of the prediction module 116. In an embodiment, the reclassification module 120 generates a final spamicity value for each host that identifies the host as either spam or non-spam.

In an alternative embodiment, the reclassification module 120 is omitted as reclassification is performed by the prediction module 116. In this alternative embodiment, the analysis performed by the prediction module 116 is repeated using the neighbor spamicity value as another feature that is considered. The result of the second analysis is a final spamicity value for each host identifying that host as either spam or non-spam.

In the embodiment shown, in FIG. 1, the search functions of the search server 112 are performed by a search engine 122. The search engine 122 operates to receive queries from users of the Internet 101 and to generate search results based on those queries. Upon receiving a query with search terms, the search engine 122 searches the index 124 for information known about the various hosts 102-110 and generates a page of search results 126. A search term may be one or more keywords, such as keywords entered into a search engine as part of a search request, for web pages matching the search term.

In the embodiment shown, the spam host identification (ID) module 114 is used to classify each of the hosts known to the system as either spam or non-spam. Using this classification, the search engine then can order the search results 126 so that spam hosts, e.g., those hosts identified as spam hosts by the spam host ID module 114, toward the end of the search result. Alternatively, spam hosts may be filtered so that they do not appear in the search result 126 at all.

In yet another embodiment, the spam host ID module 114 may be implemented as a standalone module or service on its own server or computing device (not shown) that continuously analyzes the data maintained in the index 124 and assigns each host a host spamicity value which is stored in the index. Independent search engines on other servers then need only inspect the data maintained in the index 124, which now includes the host spamicity value for each host so that search results 126 may be easily ordered based on whether a host is spam or non-spam.

FIG. 2 illustrates the contents of an example host 200. In the embodiment shown, a host 200 is a node on the network (in this case, the Internet 101) that includes pages containing content and/or links. In the embodiment shown, the host 200 includes web pages 204, 210. Each web page includes some type of content 208. Such content 208 may be text and advertisements that appear when the web page is displayed on a browser. Content 208 may also include web services, for example a web site that performs currency conversion or displays current traffic for an area. Content 208 may also include text in the form of metadata that does not appear when the web page is displayed to a user on a browser. Typically, many spam hosts have a significant amount of content contained in tags and other non-displaying metadata in order to trick content analysis algorithms into thinking that the web page is highly relevant to some keywords or search terms. In a non-spam site, content 208 is, in fact, the valuable product for which users are attempting to find and access the site.

The web pages 204, 210 further include one or more links 206. The links may be hyperlinks or other references to other web pages on the same or other hosts accessible via the network 101. It is now common for many websites to have many links on each web page. A link may be a user-selectable text, control or icon that causes the user's browser to retrieve the linked page. Alternatively, the link may be a simple address in text that the user's device identifies as link to the page identified by the address.

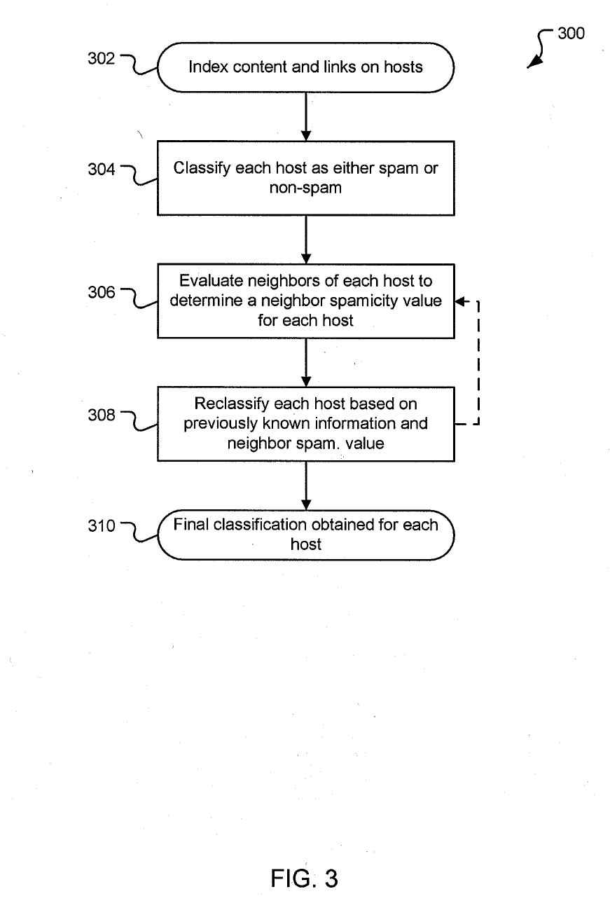

FIG. 3 illustrates a method for identifying spam hosts within a set of hosts. In the embodiment of a method 300 shown, the content and links on hosts on the network are indexed in an indexing operation 302. The indexing operation may be performed by a web crawler associated with a search engine in order to build the index for use by the search engine later in responding to queries. The indexing operation may index the content as well as the number and hosts to which each page on a host is linked.

Based on the information contained in the index, the method 300 further classifies each host in the index as either spam or non-spam in a initial classification operation 304. The initial classification of hosts as spam or non-spam may be done using any method known in the art, including methods in which the content of the pages of the hosts are analyzed, the number and type of links on each page or a representative set of pages in the host is analyzed, and/or a combination of both. Methods and algorithms for initially classifying a set of host web pages based on content and link features are known in the art. Any such method may be used in order to obtain an initial classification of each of the hosts.

In an embodiment, each host, regardless of the number of web pages associated with the host, is assigned its own spamicity value indicative of whether the host is spam or non-spam. In an alternative embodiment, each web page on a host may be assigned a web page spamicity value, thereby, in effect, modifying the systems described herein to be a spam web page identification system, as opposed to a spam host identification system.

After the host has been classified in the classification operation 306, a neighbor evaluation operation 306 is performed. In the neighbor evaluation operation 306, the neighbors for each host are identified and a neighbor spamicity value is calculated based on the initial spamicity values of the identified neighbors. As discussed above, whether a host is considered a neighbor to another host may vary depending on the definition of neighbor being used. Furthermore, the neighbor spamicity value may be determined by any suitable algorithm, such as a simple average of the initial spamicity values of the identified neighbors, a weighted average, etc.

After the neighbor spamicity values are generated, a reclassification operation 308 analyzes the information known about the various hosts again, but this time includes the neighbor spamicity value as an additional factor. In an embodiment, the reclassification operation 308 may perform the same initial classification operation previously performed using the initial information indexed for each host and the neighbor spamicity value as an additional factor.

In an alternative embodiment, a completely different analysis may be performed using some or all of the information initially known about each host and the neighbor spamicity value. For example, a threshold analysis may be performed on the neighbor spamicity value so that hosts retain their initial spam/non-spam classification unless they have a neighbor spamicity value above or below a predetermined threshold. This is but one example of a way of using neighbor spamicity to alter the initial classification of a host and others may also be used herein.

It should be noted that the neighbor spamicity operation 306 and reclassification operation 308 may be repeated one or more times. This is illustrated by a dashed arrow illustrating that the flow may return to the neighbor spamicity operation 306 from the reclassification operation 308. By repeating the operations 306, 308, the final spamicity value of the hosts may improve in accuracy as a descriptor of the actual content of the host. The number of iterations performed may be selected based on experimental data or may be selected based on changes observed between the results of the iterations.

Regardless of whether a single or multiple iterations are performed, the result of the method 300 is that each host is now identified as either spam or non-spam, as illustrated by final classification being obtained in the termination operation 310. This spam/non-spam classification may or may not be the same as the initial classification. The classification may include assigning each host a final host spamicity value that is then recorded for that host, for example in the index along with other information about the host. Alternatively, some other technique may be used to classify each host other than assigning a value to the host.

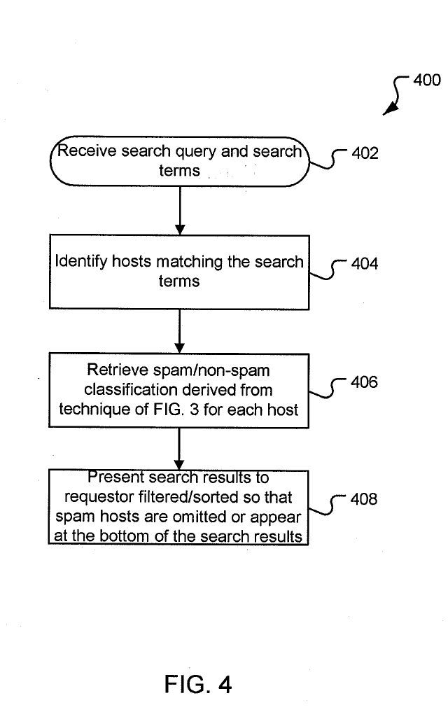

FIG. 4 illustrates an embodiment of a method 400 that uses the spam host classification information generated by FIG. 3 to change how search results are presented to users in a search system. This is but one example of how the spam host identification system may be used to alter a user's experience or the actions performed by a computing system related to displaying or analyzing hosts.

In the embodiment shown, a search engine receives a search query including search terms from a user in a receive search operation 402. In response, the search engine identifies hosts matching the search terms in a host identification operation 404. The host identification operation 404 may include identifying specific web pages within hosts that match the search terms from the search query or may only identify host sites that contain pages that match the search query. In order to match a host to a search query, the same content in the index used to classify hosts as spam or non- spam may be used to match the hosts to the query. Such matching algorithms are known in the art and any suitable algorithm may be used to identify hosts matching a search term.

Following the host identification operation 404, an retrieve classification operation 406 is performed. In the embodiment, the span/non-spam classification derived by the method described with reference to FIG. 3 is retrieved for each host identified by the search engine in the identification operation 404.

After the spam/non-spam classification of each host has been retrieved, search results are then filtered and/or sorted, based on whether each host identified in the search results is spam or non-spam and then presented to the requester of the search in a search result presentation operation 408. The search results may be sorted so that spam hosts appear at the bottom of the search results. Alternatively, spam hosts may be identified in some way to the user/requestor in the search result. In yet another embodiment, hosts identified as spam may be filtered out of the search result entirely so that they are not presented to the user in response to the user's search query. Such filtering may be in response to a user default in which the user requests that the search engine not transmit any search results likely to be spam hosts.

The method 400 for generating search results identified in FIG. 4 is but one example of how the detection of such spam hosts could be used to alter the user's experience. In an alternative embodiment, a detection system performing the method 400 may be used to identify spam hosts to potential advertisers. Advertisers may have an interest in not allowing their advertisement to be shown on spam hosts but rather, have their advertisement shown only on non-spam hosts. In this way, an advertiser may use the spam host detection system to identify potential hosts that may be suitable for the advertisement or classify hosts that currently display the advertisement.

In yet another embodiment, the systems and methods described above may be used to detect spam registrations in directories of hosts. Hosts identified as spam by the stacked graphical learning method may then be removed from the registry or flagged as spam.

In yet another embodiment, the systems and methods described above may be used to detect spam or abusive replies in a forum context, e.g., Yahoo! answers. Again, answers and hosts associated with answers identified as spam by the stacked graphical learning method may then be removed from the forum or flagged/sorted/displayed as spam.

### EXAMPLE

The following is a description of an embodiment of a spam host identification system and method that was created and tested against a known dataset of spam and non-spam hosts to determine its efficacy. The WEB SPAM-UK2006 dataset, a publicly available Web spam collection, was used as the initial dataset upon which to test the spam host identification system. It is based on a crawl of the .uk domain done in May 2006, including 77.9 million pages and over 3 billion links in about 11,400 hosts.

This reference collection has been tagged at the host level by a group of volunteers. The assessors labeled hosts as “normal”, “borderline” or “spam”, and were paired so that each sampled host was labeled by two persons independently. For the ground truth, only hosts for which the assessors agreed were used, plus the hosts in the collection marked as non-spam because they belong to special domains such as police .uk or .gov.uk.

The benefit of labeling hosts instead of individual pages is that a large coverage can be obtained, meaning that the sample includes several types of Web spam, and the useful link information among them. Since about 2,725 hosts were evaluated by at least two assessors, a tagging with the same resources at the level of pages would have been either completely disconnected (if pages were sampled uniformly at random), or would have had a much smaller coverage (if a sub set of sites were picked at the beginning for sampling pages). On the other hand, the drawback of the host-level tagging is that a few hosts contain a mix of spam/non-spam content, which increases the classification errors. Domain-level tagging is another embodiment that could be used.

Evaluation. The evaluation of the overall process is based on a set of measures commonly used in Machine Learning and Information Retrieval. Given a classification algorithm C, we consider its confusion matrix:

Prediction

| | | Non-spam | Spam |
|---|---|---|---|
| True Label | Non-spam | a | b |
| | Spam | c | d |

where a represents the number of non-spam examples that were correctly classified, b represents the number of nonspam examples that were falsely classified as spam, c represents the spam examples that were falsely classified as nonspam, and d represents the number of spam examples that were correctly classified. We consider the following measures: true positive rate (or recall), false positive rate and F-measure. The recall R is d/(c+d). The false positive rate is defined as b/(b+a). The F-Measure is defined as F=2PR/(P+R), where P is the precision P=d/(b+d).

For evaluating the classification algorithms, we focus on the F-measure F as it is a standard way of summarizing both precision and recall. We also report the true positive rate and false positive rate as they have a direct interpretation in practice. The true positive rate R is the amount of spam that is detected (and thus deleted or demoted) by the search engine. The false positive rate is the fraction of non-spam objects that are mistakenly considered to be spam by the automatic classifier.

Cross-validation. All the predictions reported here were computed using tenfold cross validation. For each classifier, the true positives, false positives and F-measure were reported. A classifier whose prediction it is desired to estimate, is trained 10 times, each time using the 9 out of the 10 partitions as training data and computing the confusion matrix using the tenth partition as test data. The resulting ten confusion matrices are then averaged and the evaluation metrics on the average confusion matrix are estimated.

For the content analysis, a summary of the content of each host was obtained by taking the first 400 pages reachable by breadth-first search. The summarized sample contains 3.3 million pages. All of the content data used in the rest of this paper were extracted from a summarized version of the crawl. Note that the assessors spent on average 5 minutes per host, so the vast majority of the pages they inspected were contained in the summarized sample.

The spam detection system then used a cost-sensitive decision tree as part of the classification process. Experimentally, this classification algorithm was found to work better than other methods tried. The features used to learn the tree were derived from a combined approach based on link and content analysis to detect different types of Web spam pages.

The features analyzed to build the classifiers were extracted link-based features from the Web graph and hostgraph, and content-based features from individual pages. For the link-based features the method described by L. Becchetti, C. Castillo, D. Donato, S. Leonardi, and R. Baeza-Yates in Link-based characterization and detection of Web Spam. In AIR Web, 2006 was used and for the content-based features the method described by A. Ntoulas, M. Najork, M. Manasse, and D. Fetterly in Detecting spam web pages through content analysis. In WWW, pages 83-92, Edinburgh, Scotland, May 2006 was used.

Most of the link-based features were computed for the home page and the page in each host with the maximum Page-Rank. The remainder of link features were computed directly over the graph between hosts (obtained by collapsing together pages of the same host).

Degree-related measures. A number of measures were computed related to the in-degree and out-degree of the hosts and their neighbors. In addition, various other measures were considered, such as the edge-reciprocity (the number of links that are reciprocal) and the assortativity (the ratio between the degree of a particular page and the average degree of its neighbors). A total of 16 degree-related features was obtained.

PageRank. PageRank is a well known link-based ranking algorithm that computes a score for each page. Various measures related to the PageRank of a page and the PageRank of its in-link neighbors were calculated to obtain a total of 11 PageRank-based features.

TrustRank. Gy ongyi et al. (Z. Gy ongyi, H. Garcia-Molina, and J. Pedersen. Combating Web spam with TrustRank. In VLDB, 2004) introduced the idea that if a page has high PageRank, but it does not have any relationship with a set of known trusted pages then it is likely to be a spam page. TrustRank is an algorithm that, starting from a subset of hand-picked trusted nodes and propagating their labels through the Web graph, estimates a TrustRank score for each page. Using TrustRank the spam mass of a page, i.e., the amount of PageRank received from a spammer, may be estimated. The performance of TrustRank depends on the seed set. In the experiment 3,800 nodes were chosen at random from the Open Directory Project, excluding those that were labeled as spam. It was observed that the relative non-spam mass for the home page of each host (the ratio between the TrustRank score and the PageRank score) is a very effective measure for separating spam from non-spam hosts. However, using this measure alone is not sufficient for building an automatic classifier because it would yield a high number of false positives (around the 25%).

Truncated PageRank. Becchetti et al. described Truncated PageRank, a variant of PageRank that diminishes the influence of a page to the PageRank score of its neighbors.

Estimation of supporters. Given two nodes x and y, it is said that x is a d-supporter of y, if the shortest path from x to y has length d. Let N_{d}(x) be the set of the d-supporters of page x. An algorithm for estimating the set N_{d}(x) for all pages x based on probabilistic counting is described in Becchetti et al. For each page x, the cardinality of the set N_{d}(x) is an increasing function with respect to d. A measure of interest is the bottleneck number b_{d}(x) of page x, which we define to be b_{d}(x)=min_{j≦d}{|Nⱼ(x)|/|Nⱼ₋₁(x)|}. This measure indicates the minimum rate of growth of the neighbors of x up to a certain distance. We expect that spam pages form clusters that are somehow isolated from the rest of the Web graph and they have smaller bottleneck numbers than nonspam pages.

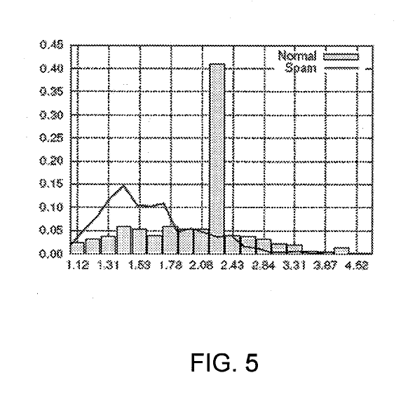

FIG. 5 shows a histogram of b_{d}(x) for spam and non-spam pages. For most of the non-spam pages, the bottleneck number is around 2.2, while for many of the spam pages it is between 1.3 and 1.7.

For each web page in the data set a number of features were extracted based on the content of the pages. Most of the features reported by Ntoulas et al. were used, with the addition of new ones such as the entropy (see below), which is meant to capture the compressibility of the page. Ntoulas et al. use a set of features that measures the precision and recall of the words in a page with respect to the set of the most popular terms in the whole web collection. A new set of features was also used that measures the precision and recall of the words in a page with respect to the q most frequent terms from a query log, where q=100, 200, 500, 1000.

Number of words in the page, number of words in the title, average word length. For these features the method counted only the words in the visible text of a page, and we consider words consisting only of alphanumeric characters.

Fraction of anchor text. This feature was defined as the fraction of the number of words in the anchor text to the total number of words in the page.

Fraction of visible text. The fraction of the number of words in the visible text to the total number of words in the page, include html tags and other invisible text, was also used as a feature.

Compression rate. The visible text of the page was compressed using bzip. Compression rate is the ratio of the size of the compressed text to the size of the uncompressed text.

Corpus precision and corpus recall. The k most frequent words in the dataset, excluding stopwords, was used as a classification feature. Corpus precision refers to the fraction of words in a page that appear in the set of popular terms. Corpus recall was defined to be the fraction of popular terms that appear in the page. For both corpus precision and recall 4 features were extracted, for k=100, 200, 500 and 1000.

Query precision and query recall. The set of q most popular terms in a query log was used, and query precision and recall analogous to corpus precision and recall. As with corpus precision and recall, eight features were extracted, for q=100, 200, 500 and 1000.

Independent trigram likelihood. A trigram is three consecutive words. Let {p_{w}} be the probability distribution of trigrams in a page. Let T={w} be the set of all trigrams in a page and k=|T(p)| be the number of distinct trigrams. Then the independent trigram likelihood is a measure of the independence of the distribution of trigrams. It is defined as P in Ntoulas et al. to be

$$- \frac{1}{k} {\sum }_{w ∈ T} log {p}_{w} .$$

Entropy of trigrams. The entropy is another measure of the compressibility of a page, in this case more macroscopic than the compressibility ratio feature because it is computed on the distribution of trigrams. The entropy of the distribution of trigrams, {p_{w}}, is defined as

H=−Σ_{wεT}pw log pw

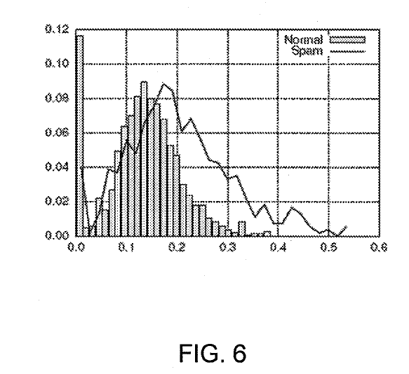

The above list gives a total of 24 features for each page. In general we found that, for this dataset, the content-based features do not provide as good separation between spam and non-spam pages as for the data set used in Ntoulas et al. For example, we found that in the dataset we are using, the distribution of average word length in spam and non-spam pages were almost identical. In contrast, for the data set of Ntoulas et al. that particular feature provides very good separation. The same is true for many of the other content features. Some of the best features (judging only from the histograms) are the corpus precision and query precision, which is shown in FIG. 6.

In total, 140 features were extracted for each host and 24 features for each page. The total number of link-based features, as described above, is 140 features for each host. The content-based features of pages were aggregated in order to obtain content-based features for hosts.

Let h be a host containing m web pages, denoted by the set P={p₁, . . . ,pₘ}. Let \hat{p} denote the home page of host h and p* denote the page with the largest PageRank among all pages in P. Let c(p) be the 24-dimensional content feature vector of page p. For each host h we form the content-based feature vector c(h) of h as follows

c(h)=<c(\hat{p}), c(p*), E[c(p)], Var[c(p)]>.

Here E[c(p)] is the average of all vectors c(p), p ε P, and Var[c(p)] is the variance of c(p), p ε P. Therefore, for each host there were 4×24=96 content features. In total, there were 140+96=236 link and content features.

In the process of aggregating page features, hosts h were ignored for which the home page \hat{p} or the maxPR page p* is not present in our summary sample. This left a total of 8,944 hosts, out of which 5,622 are labeled; from them, 12% are spam hosts.

The base classifier used in the experiment was the implementation of C4.5 (decision trees) given in Weka (see e.g., I. H. Witten and E. Frank. Data Mining: Practical Machine Learning Tools and Techniques with Java Implementations. Morgan Kaufmann, 1999.). Using both link and content features, the resulting tree used 45 unique features, of which 18 were content features.

In the data used, the non-spam examples outnumber the spam examples to such an extent that the classifier accuracy improves by misclassifying a disproportionate number of spam examples. To minimize the misclassification error, and compensate for the imbalance in class representation in the data, a cost-sensitive decision tree was used. A cost of zero was imposed for correctly classifying the instances, and the cost of misclassifying a spam host as normal was set to be R times more costly than misclassifying a normal host as spam. Table 1 shows the results for different values of R. The value of R is a parameter that can be tuned to balance the true positive rate and the false positive rate. In this case, it was desired to maximize the F-measure. Incidentally note that R=1 is equivalent to having no cost matrix, and is the baseline classifier.

TABLE 1
Cost-sensitive decision tree

| | Cost ratio (R) | | | | |
|---|---|---|---|---|---|
| | 1 | 10 | 20 | 30 | 50 |
| True positive rate | 64.0% | 68.0% | 75.6% | 80.1% | 87.0% |
| False positive rate | 5.6% | 6.8% | 8.5% | 10.7% | 15.4% |
| F-Measure | 0.632 | 0.633 | 0.646 | 0.642 | 0.594 |

It was then attempted to improve the results of the baseline classifier using bagging. Bagging is a technique that creates an ensemble of classifiers by sampling with replacement from the training set to create N classifiers whose training sets contain the same number of examples as the original training set, but may contain duplicates. The labels of the test set are determined by a majority vote of the classifier ensemble. In general, any classifier can be used as a base classifier, and in this experiment the cost-sensitive decision trees described above were used. Bagging improved our results by reducing the false-positive rate, as shown in Table 2. The decision tree created by bagging was roughly the same size as the tree created without bagging, and used 49 unique features, of which 21 were content features.

TABLE 2
Bagging with a cost-sensitive decision tree

| | Cost ratio (R) | | | | |
|---|---|---|---|---|---|
| | 1 | 10 | 20 | 30 | 50 |
| True positive rate | 65.8% | 66.7% | 71.1% | 78.7% | 84.1% |
| False positive rate | 2.8% | 3.4% | 4.5% | 5.7% | 8.6% |
| F-Measure | 0.712 | 0.703 | 0.704 | 0.723 | 0.692 |

The results of classification reported in Tables 1 and 2 use both link and content features. Table 3 shows the contribution of each type of feature to the classification. The content features serve to reduce the false-positive rate, with-out diminishing the true positive result, and thus improve the overall performance of the classifier.

TABLE 3
Comparing link and content features

| | Both | Link-only | Content-only |
|---|---|---|---|
| True positive rate | 78.7% | 79.4% | 64.9% |
| False positive rate | 5.7% | 9.0% | 3.7% |
| F-Measure | 0.723 | 0.659 | 0.683 |

Given the above, an embodiment of the methods described above then was analyzed in which during the extraction of link-based features, all nodes in the network were anonymous, while in this regularization phase, the identity (the predicted label or initial host spamicity value) of each node is known, and important to the algorithm.

Stacked graphical learning is a meta-learning scheme described recently by Cohen and Kou (W. W. Cohen and Z. Kou. Stacked graphical learning:approximating learning in markov random fields using very short inhomogeneous markov chains. Technical report CMU-ML-07-101, 2006.). It uses a base learning scheme C to derive initial predictions for all the objects in the dataset. Then it generates a set of extra features for each object, by combining the predictions for the related objects in the graph. Finally, it adds this extra feature to the input of C, and runs the algorithm again to get new, hopefully better, predictions for the data.

In the experiment, the following stacked graphical learning system was used. Let p(h) ε [0 . . . 1] be the prediction of a particular classification algorithm C as described above. Let r(h) be the set of pages related to h in some way. The method then computes:

$$f ( h ) = \frac{{\sum }_{g ∈ r ( h )} p ( g )}{\vert r ( h ) \vert}$$

Next, f(h) is added as an extra feature for instance h in the classification algorithm C, and the classification algorithm is run again. This process can be repeated many times, but it was experimentally determined that most of the improvement was obtained with the first iteration.

Table 4 reports the results of applying stacked graphical learning, by including one extra feature with the average predicted spamicity of r(h). For the set r(h) of pages related to h, pages that were neighbors because of in-links, out-links or both (i.e., bi-directional neighbors) were analyzed.

TABLE 4
Results with stacked graphical learning

| | | Avg. | Avg. of out- | |
|---|---|---|---|---|
| | Baseline | of in-linked | linked | Avg. of both |
| True positive rate | 78.7% | 84.4% | 78.3% | 85.2% |
| False positive rate | 5.7% | 6.7% | 4.8% | 6.1% |
| F-Measure | 0.723 | 0.733 | 0.742 | 0.750 |

It can be observed from above that there is an improvement over the baseline, and the improvement is more noticeable when using the entire neighborhood of the host as an input. The improvement is statistically significant at the 0.05 confidence level. In comparison with the other techniques studied, this method is able to significantly improve even the classifier with bagging.

A second iteration (see Table 5) of stacked graphical learning yields an even better performance; the false positive rate increased slightly but the true positive rate increased by almost 3%, compensating for it and yielding a higher F-measure. The feature with the highest information gain was the added feature, and so serves as a type of summary of other features. With the added feature, the resulting decision tree is smaller, and uses fewer link features; the tree uses 40 features, of which 20 are content features. Consistently with Cohen and Kou, doing more iterations does not improve the accuracy of the classifier significantly.

TABLE 5
Second pass of stacked graphical learning

| | Baseline | First pass | Second pass |
|---|---|---|---|
| True positive rate | 78.7% | 85.2% | 88.4% |
| False positive rate | 5.7% | 6.1% | 6.3% |
| F-Measure | 0.723 | 0.750 | 0.763 |

The improvement of the F-Measure from 0.723 to 0.763 was of about 5.5%, and this actually translates to a large improvement in the accuracy of the classifier. The techniques described herein improved the detection rate from 78.7% to 88.4%, while the error rate grew by less than one percentage point, from 5.7% to 6.3%.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations, order of operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure. For example, a spam host identification system could be incorporated into an automated news aggregation system so that pages from spam hosts are not accidentally aggregated as non-spam news items. Numerous other changes may be made that will readily suggest themselves to those skilled in the art and which are encompassed in the spirit of the invention disclosed and as defined in the appended claims.

What is claimed is:

1. A method for identifying spam hosts within a set of hosts comprising:
indexing content on each host within the set of hosts on a network;
indexing links on each host within the set of hosts on the network;
assigning each host an initial host spamicity value identifying the host as spam or non-spam based on a first analysis of the information known about that host;
for a first host, determining a neighbor spamicity value based on the initial spamicity values of neighbors of the first host; and
assigning the first host a final host spamicity value identifying the host as spam or non-spam based on a second analysis of the information known about the first host and the neighbor spamicity value of the neighbors of the first host.

2. The method of claim 1, wherein determining a neighbor spamicity value further comprises:
identifying neighbors of the first host based on information about link on the first host contained in the index.

3. The method of claim 1, wherein determining a neighbor spamicity value further comprises:
determining the neighbor spamicity value based on an aggregate function of the initial spamicity values of the neighbors of the first host.

4. The method of claim 1, wherein assigning each host an initial host spamicity value further comprises:
assigning the initial host spamicity value based on the information indexed in the indexing operations.

5. The method of claim 1, wherein assigning each host an initial host spamicity value further comprises:
assigning the initial host spamicity value based on at least one of the content on that host, the number of links between that host and other hosts, and a similarity measure describing the similarity between the hosts.

6. The method of claim 1 further comprising:
for a second host, determining a neighbor spamicity value of neighbors of the second host; and
assigning the second host a final host spamicity value identifying the host as spam or non- spam based on an analysis of the information known about the second host and the neighbor spamicity value for the second host.

7. A method for presenting a list of hosts as search results in response to a search query comprising:
receiving, from a requester, a search query requesting a list of hosts matching a search term;
identifying hosts matching the search term;
assigning a host spamicity value to each host matching the search term, based on content and links on that host and content and links of neighbors of that host, the host spamicity value of each host identifying the host as either a spam host or a non-spam host; and
presenting, to the requestor, the list of the hosts matching the search term, wherein the list is sorted at least in part based on the host spamicity value of each host in the list.

8. The method of claim 7, further comprising:
generating the list of the hosts matching the search term; and
sorting the list so that hosts with host spamicity values indicative of non-spam hosts are listed before hosts with host spamicity values indicative of spam hosts.

9. The method of claim 7, wherein assigning a host spamicity value to each host further comprises:
assigning each host an initial host spamicity value identifying the host as spam or non-spam based on an first analysis of the information known about that host;
for a first host, determining a neighbor spamicity value based on the initial spamicity values of neighbors of the first host; and
assigning the first host a final host spamicity value identifying the host as spam or non-spam based on a second analysis of the information known about the first host and the neighbor spamicity value of the neighbors of the first host.

10. The method of claim 9, wherein assigning each host an initial spamicity value further comprises:
identifying neighbors of the first host based on information about link on the first host contained in the index.

11. The method of claim 9, wherein assigning each host an initial spamicity value further comprises:
determining the neighbor spamicity value by calculating an average of the initial spamicity values of the neighbors of the first host.

12. The method of claim 9, wherein assigning each host an initial spamicity value further comprises:
assigning the initial spamicity value based on the content on that host and the number of links between that host and other hosts.

13. The method of claim 9, wherein assigning each host a host spamicity value further comprises:
repeating an analysis used to determine the initial host spamicity value of the first host using the neighbor spamicity value for the first host as an additional feature of the analysis.

14. A system for generating a list of search results comprising:
a spam host identification module that identifies each of a plurality of hosts as either a spam host or a non-spam host based on content and links on that host and further based on content and links of neighbors of that host.

15. The system of claim 14, wherein the spam host identification module further includes a prediction module that initially classifies each host in the plurality of hosts as either a spam host or a non-spam host based on at least the content on that host.

16. The system of claim 15, wherein the spam host identification module further includes a neighbor spamicity module that determines a neighbor spamicity value for each host, the neighbor spamicity value based on an initial classification of neighboring hosts based on links between each host and other hosts.

17. The system of claim 16, wherein the spam host identification module further includes a reclassification module that changes the initial classifications for at least some of the hosts based on the content of the host and the neighbor spamicity value of the host.

18. The system of claim 14 further comprising:
an index containing information describing the content and links of a set of hosts on a network.

19. The system of claim 18, wherein the spam host identification module stores information in the index identifying each of the plurality of hosts as either a spam host or a non-spam host.

20. The system of claim 14 further comprising:
a search engine that receives a search query including a search term, identifies hosts matching the search term based on information contained in the index, and transmits a list of hosts matching the search term in which the order in which the hosts matching the search term appear in list is based at least in part on whether the host is identified as a spam host or a non-spam host by the spam host identification module.

21. A computer-readable medium storing computer executable instructions for a method for identifying spam hosts within a set of hosts, the method comprising:
assigning each host an initial host spamicity value identifying the host as spam or non-spam based on a first analysis of the information known about that host;
for a first host, determining a neighbor spamicity value based on the initial spamicity values of neighbors of the first host; and
assigning the first host a final host spamicity value identifying the host as spam or non-spam based on a second analysis of the information known about the first host and the neighbor spamicity value of the neighbors of the first host.

22. The computer-readable medium of claim 21, wherein determining a neighbor spamicity value further comprises:
identifying neighbors of the first host based on information about link on the first host contained in the index.

23. The computer-readable medium of claim 21, wherein determining a neighbor spamicity value further comprises:
determining the neighbor spamicity value by calculating an average of the initial spamicity values of the neighbors of the first host.

24. The computer-readable medium of claim 21, wherein assigning each host an initial host spamicity value further comprises:
assigning the initial host spamicity value based on the content on that host and the number of links between that host and other hosts.

25. The computer-readable medium of claim 21 wherein assigning the first host a final host spamicity value further comprises:
repeating the first analysis using the neighbor spamicity value for the first host as an additional feature in the first analysis.
